(19) United States
(12) Patent Application Publication
(10) Pub. No.: US 2015/0282028 A1
(43) Pub. Date: Oct. 1, 2015

(54) METHOD AND SYSTEM FOR REDUCING SIGNALING OVERHEAD IN WIRELESS COMMUNICATION

(71) Applicant: Samsung Electronics Co., Ltd., Gyeonggi-do (KR)

(72) Inventors: Tushar VRIND, Gyeonggi-do (KR); Prasad Basavaraj Dandra, Bangalore (IN)

(73) Assignee: Samsung Electronics Co., Ltd.

(21) Appl. No.: 14/663,793

(22) Filed: Mar. 20, 2015

Related U.S. Application Data
(60) Provisional application No. 61/973,545, filed on Apr. 1, 2014.

(30) Foreign Application Priority Data
Feb. 11, 2015 (KR) 10-2015-0020833

(51) Int. Cl. H04W 36/14; H04W 76/02; H04W 36/00

(52) U.S. Cl. CPC H04W 36/14; H04W 36/0016; H04W 76/023

(57) ABSTRACT

A system and method are provided for reducing signaling overhead in a wireless communication system. The method includes establishing device-to-device communication between a first User Equipment (UE1) and a second User Equipment (UE2) over a locally routed data path; sending, by the UE1, a signal quality measurement report to a network; identifying, by the network, that the UE1 is locally routed for proximity services with the UE2; applying, by the network, cell biasing to a serving cell for at least one of the UE1 or the UE2; verifying, after the cell biasing, whether the at least one of the UE1 or the UE2 sustains a connection with the serving cell; and continuing the proximity services through the locally routed data path, if the at least one of the UE1 or the UE2 sustains the connection with the serving cell.

### PRIORITY

This application claims priority under 35 U.S.C. §119 to U.S. Provisional Application Ser. No. 61/973,545, which was filed in the U.S. Patent and Trademark Office on Apr. 1, 2014, and to Korean Application Ser. No. 10-2015-0020833, which was filed in the Korean Intellectual Property Office on Feb. 11, 2015, the entire content of each of which is incorporated herein by reference.

### BACKGROUND

1. Field of the Disclosure

The present invention relates generally to proximity based device-to-device communication, and more particularly, to a method and a system for reducing overhead communication between a pair of devices in proximity of each other in an Evolved Universal Terrestrial Radio Access Network (E-UTRAN).

2. Description of the Related Art

Proximity-based applications and services are used to discover instances of applications running on devices that are within certain proximity of each other, and exchange application-related data for a variety of reasons, e.g., commercial/social use, network offloading, integration of current infrastructure services, public safety, etc.

FIG. 1 illustrates a conventional default data path scenario in an Evolved Packet System (EPS) for communication between two User Equipments (UEs).

Referring to FIG. 1, even when UE 102 and UE 104 are in close proximity with each other, their respective data paths still pass via an operator network, i.e., through evolved Node Bs (or E-UTRAN Node Bs or eNodeB) (eNBs) 106 and 108 and Serving Gateway/Packet Data Network Gateway (SGW/PGW) 110. These particular data paths are lengthy, time consuming, and not cost effective.

However, if UEs are in close proximity to each other, they may be able to use a “direct mode” or a “locally-routed” path, as described below.

FIG. 2 illustrates a conventional direct mode data path in an EPS for communication between two UEs.

Referring to FIG. 2, in the 3^{rd} Generation Partnership Project (3GPP) Long Term Evolution (LTE) spectrum, an operator can move a data path off of access and core networks and onto direct links between UE 202 and UE 204. Basically, the UE 202 and the UE 204 communicate directly, without involving eNB(s) 206 and 208 and SGW/PGW 210.

FIG. 3 illustrates a conventional locally-routed data path in an EPS for communication between two UEs.

Referring to FIG. 3, a data path between UE 302 and UE 304 is locally-routed through an eNB 306.

FIG. 4 illustrates a conventional control path for network-supported Proximity Services (Pro-Se) communication for UEs served by a same eNB.

Referring to FIG. 4, when UEs 402 and 404, which are involved in Pro-Se communication, are both served by eNB 406 and network coverage is available, the system can decide to perform Pro-Se communication using control information exchanged between the UEs 402 and 404, the eNB 406, and an Evolved Packet Core (EPC) 408 (e.g., session management, authorization, security, etc.), as shown by the solid arrows. The UEs 402 and 404 can also exchange control signaling via the Pro-Se communication path, as shown by the dashed arrow between UE 402 and UE 404.

FIG. 5 illustrates a conventional control path for network-supported Pro-Se communication for UEs served by different eNBs.

Referring to FIG. 5, when UEs 502 and 504, which are involved in Pro-Se communication, are served by eNBs 506 and 508, respectively, and network coverage is available, the system can decide to perform Pro-Se communication using control information exchanged between the UEs 502 and 504, the eNBs 506 and 508, and an EPC 510 (e.g., session management, authorization, security, etc.), as shown by the solid arrows. In this configuration, the eNBs 506 and 508 may coordinate with each other through the EPC 510 or communicate directly for radio resource management, as shown by the dashed arrow between the eNB(s) 506 and 508. In addition, the UEs 502 and 504 can exchange control signaling via the Pro-Se communication path, as shown by the dashed arrow between UE 502 and UE 504.

FIG. 6 illustrates a conventional method of a locally routed data path changing into a default data path.

Referring to FIG. 6, for a data path which is not a “direct data path”, e.g., is a “locally routed data path” 602, as illustrated in FIG. 3, during communication between a pair of UEs in proximity based device communication, if there is a change in an eNB, due to one of the UEs moving closer to a cell boundary, it is possible that the locally routed data path 602 could become a default data path 604. However, this could increase network load and cause un-necessary delays, due to the multi-hop traversal involved in the default data path 604, especially in public safety kind of uses.

In view of the foregoing, there is a need for a solution that provides a system and a method for reducing network overhead in an E-UTRAN for a proximity based service environment.

### SUMMARY

The various embodiments described herein have been made to address the above-described shortcomings, disadvantages, and problems occurring in the prior art, and to provide the advantages as described below.

Specifically, the various embodiments herein disclose a method of reducing signaling overhead in a wireless communication system. The method includes establishing device-to-device communication between a first User Equipment (UE1) and a second User Equipment (UE2) over a locally routed data path; sending, by the UE1, a signal quality measurement report to a network; identifying, by the network, that the UE1 is locally routed for proximity services with the UE2; applying, by the network, cell biasing to a serving cell for at least one of the UE1 or the UE2; verifying, after the cell biasing, whether the at least one of the UE1 or the UE2 sustains a connection with the serving cell; and continuing the proximity services through the locally routed data path, if the at least one of the UE1 or the UE2 sustains the connection with the serving cell.

Embodiments further disclose a method for reducing overhead in an EUTRAN during proximity based device communication. The method includes establishing device-to-device communication between a first User Equipment (UE1) and a second User Equipment (UE2) over a locally routed data path; sending, by the UE1, a signal quality measurement report to a network; identifying, by the network, that the UE1 is locally routed for proximity services with the UE2; sending, by the network, to at least one of the UE1 or the UE2, a change cell command for adding cell bias for a serving cell; verifying whether the at least one of the UE1 or the UE2 sustains a connection with the serving cell, after the cell biasing; and continuing with the proximity services through the locally routed data path, if the at least one of the UE1 or the UE2 sustains the connection with the serving cell.

Embodiments herein further disclose a network apparatus is provided for reducing signaling overhead in a wireless communication system. The network apparatus includes a transceiver for communicating with a first user equipment (UE1) that performs device-to-device (D2D) communication with a second user equipment (UE2) over a locally routed data path; and a controller configured to control receiving, from the UE1, a signal quality measurement report, to identify if the UE1 is locally routed for proximity services with the UE2, to apply cell biasing to a serving cell for at least one of the UE1 or the UE2, to verify whether the at least one of the UE1 or the UE2 sustains connection with the serving cell, after the cell biasing, and to control continuing the proximity services through the locally routed data path, if the at least one of the UE1 or the UE2 sustains the connection with the serving cell.

### BRIEF DESCRIPTION OF THE DRAWINGS

The above and other aspects, features, and advantages will be more apparent to those skilled in the art from the following detailed description taken in conjunction with the accompanying drawings, in which:

FIG. 1 illustrates a conventional default data path scenario in an EPS for communication between two UEs;

FIG. 2 illustrates a conventional direct mode data path in an EPS for communication between two UEs;

FIG. 3 illustrates a conventional locally-routed data path in an EPS for communication between two UEs;

FIG. 4 illustrates a conventional control path for network-supported Pro-Se communication for UEs served by a same eNB;

FIG. 5 illustrates a conventional control path for network-supported Pro-Se communication for UEs served by different eNBs;

FIG. 6 illustrates a conventional method of a locally routed data path changing into a default data path;

FIG. 7 illustrates a method of handover of UE2 to eNB2, where UE2 is located at a cell boundary, according to an embodiment of the present disclosure;

FIG. 8 illustrates possible data paths during a handover, according to an embodiment of the present disclosure;

FIG. 9 is a flowchart illustrating a method for Network Applied Bias in a locally routed data path, according to an embodiment of the present disclosure; and

FIG. 10 is a flowchart illustrating a method for UE Applied Bias in a locally routed data path, according to an embodiment of the present disclosure.

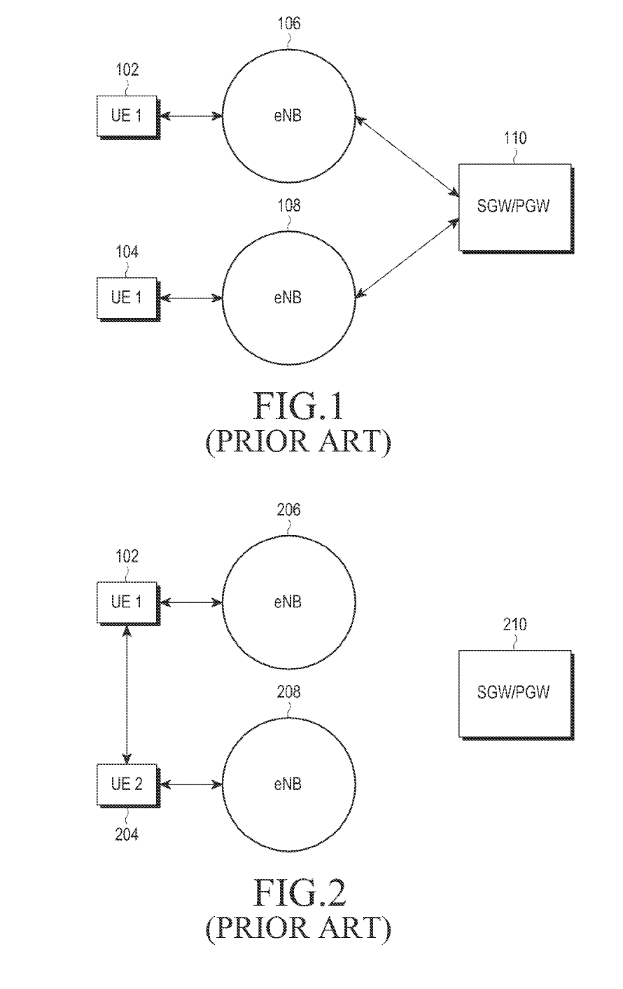

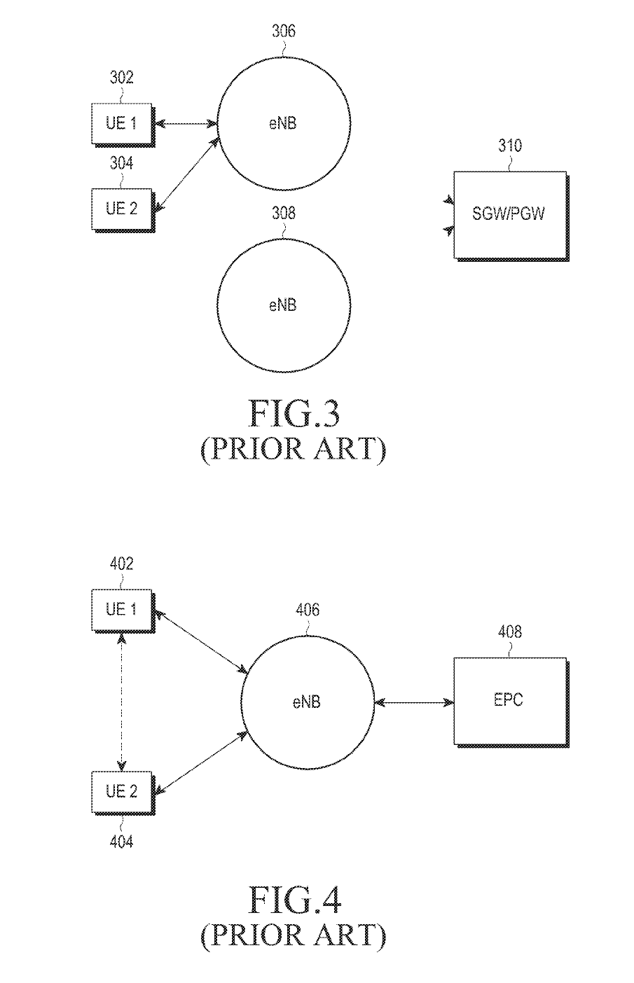

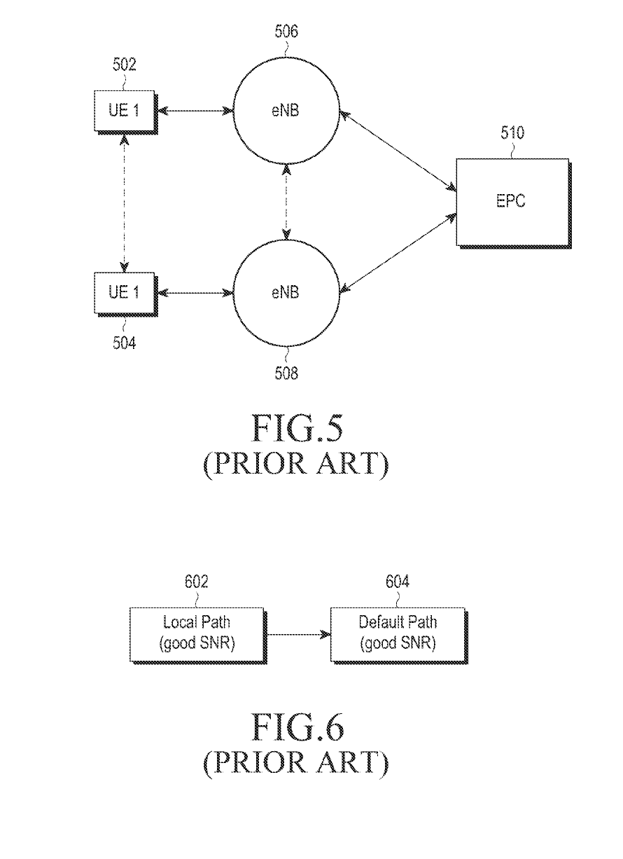

Although specific features are illustrated in some drawings and not in others, this is done for convenience only as each feature may be combined with any or all of the other features of different embodiments.

### DETAILED DESCRIPTION

Various embodiments of the present disclosure will now be described in detail with reference to the accompanying drawings. In the following description, specific details such as detailed configuration and components are merely provided to assist the overall understanding of these embodiments. Therefore, it should be apparent to those skilled in the art that various changes and modifications of the embodiments described herein can be made without departing from the scope and spirit thereof. In addition, descriptions of well-known functions and constructions are omitted for clarity and conciseness.

The specification may refer to “an”, “one” or “some” embodiment(s) in several locations, which does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by a person having ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Herein, a system and a method for reducing overhead in E-UTRAN during proximity based device communication are provided. UEs communicating through a locally routed data path may communicate in a default data path. In accordance with an embodiment of the present disclosure, a system and a method are provided to decrease the network load and un-necessary delays due to multi-hop traversal involved in a ‘default data path’; especially, in public safety situations.

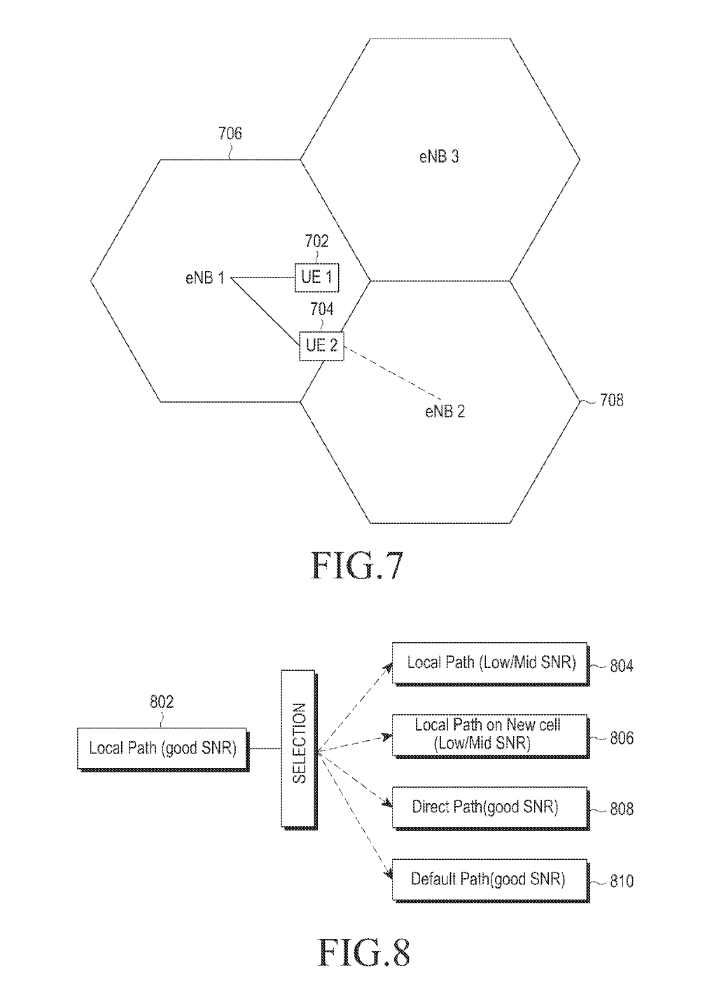

FIG. 7 illustrates a method of handover of UE2 to eNB2, where the UE2 is located at a cell boundary, according to an embodiment of the present disclosure.

Referring to FIG. 7, UE1 702 and UE2 704 are communicating through a locally routed data path via eNB1 (or Cell1) 706. Because UE2 704 is located at the cell boundary, even if UE2 704 experiences small movement, its geometry could change, resulting in eNB2 (or Cell2) 708 being better suited for UE2 704. It may be possible for UE2 704 to remain connected through eNB1 706 during that time, or connect through eNB2 708 by adapting to any of the data paths, as will be explained below with reference to FIG. 8.

Further, a network can apply a cell bias towards the serving cell eNB1 706 during handover evaluation, when UE1 702 and UE2 704 have a locally routed data path for communication.

For example, cell biasing can be done at the network or at the UE depending on the configuration. If the network applies a cell bias, it can be done during a handover evaluation. However, if a UE is to apply a cell bias, then it is shared via dedicated mode signaling. The cell bias could be in terms of X dBm to be applied to the measured signal of serving cell.

Additionally, if cell bias is to be applied, it could also be applied using priority inversion, if a target eNB is higher in priority than the serving eNB.

FIG. 8 illustrates possible data paths during a handover, according to an embodiment of the present disclosure.

Referring to FIG. 8, during a handover evaluation, if UEs are currently communicating via a locally routed data path 802, a locally routed data path on the same cell 804, a locally routed data path on a new cell 806, a direct data path 808 between two UEs, or a lengthy default data path 810 may be selected.

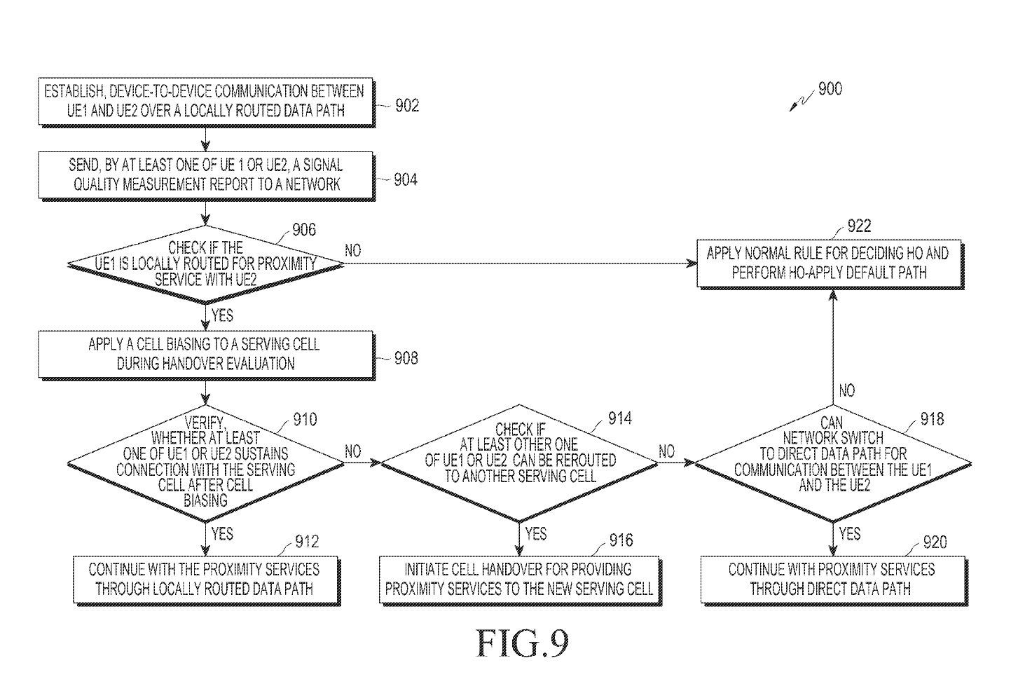

FIG. 9 is a flowchart illustrating a method for reducing signaling overhead in a wireless communication with Network Applied Bias in a locally routed data path, according to an embodiment of the present disclosure.

Referring to FIG. 9, at step 902, device-to-device communication is established between a UE1 and UE2 over a locally routed data path on a same network cell.

At step 904, at least one of UE1 and UE2 sends a signal quality measurement report to a network.

At step 906, the network checks if the UE that sent the report is locally routed for proximity service with another UE. If the UE that sent the report is not locally routed for proximity service with another UE, a default data path and a normal rule for deciding a handover and performing the handover are applied at step 922. However, if the UE that sent the report is locally routed for proximity service with another UE, then during a handover evaluation, the network applies a cell biasing to a serving cell for one of the UE and reduces the data path overload on the network at step 908.

At step 910, the network verifies whether the UE can sustain the connection with the serving cell, after cell biasing is applied. If connection is sustained, the proximity services continue through the locally routed data path at step 912. However, if the connection is not sustained, at step 914, the network determines if another UE can be rerouted to another serving cell.

If rerouting is possible to another serving cell at step 914, the network initiates a cell handover for providing proximity services to the new serving cell so that both the UEs are communicating with a locally routed data path over another serving cell at step 916.

However, if rerouting is not possible to another serving cell at step 914, the network determines if a data path can be a direct data path for communication between both the UEs at step 918. If the data path can be a direct data path for communication between both the UEs, the network establishes a direct data path and proximity services are provided over a direct data path between both the UEs at step 920. However, if the data path cannot be a direct data path for communication between both the UEs, then the network applies the default data path and the normal rule for deciding the handover and performing the handover at step 922.

As illustrated in FIG. 9, both the UEs having locally routed data path for communication may be kept on same serving cell for as long as possible. In the worst case, even after applying the cell bias, when the new cell is better for a handover evaluation, the network may decide to handover UE to the new cell, and simultaneously redirect another UE from serving cell to the new cell, or either to allow a “direct data path” between the two UEs, or a “default data path” between the two UEs, if the serving cells for both the UEs should be different.

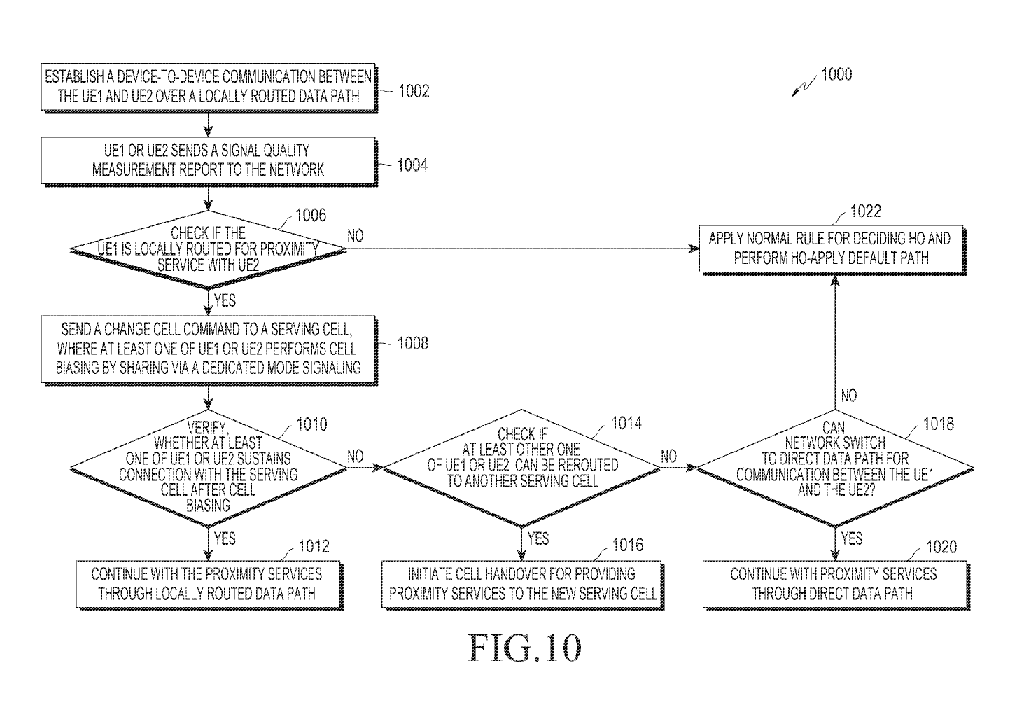

FIG. 10 is a flowchart illustrating a method for reducing signaling overhead in a wireless communication with UE Applied Bias in a locally routed data path, according to an embodiment of the present disclosure.

Referring to FIG. 10, at step 1002, a device-to-device communication is established between a UE1 and a UE2 over a locally routed data path on a same network cell.

At step 1004, at least one of the UEs sends a signal quality measurement report to a network.

At step 1006, the network checks if the UE that sent the signal quality measurement report is locally routed for proximity service with another UE. If the UE that sent the signal quality measurement report is not locally routed for proximity service with another UE, the network applies a default data path and a normal rule for deciding a handover and performing the handover at step 1022. However, if the UE that sent the signal quality measurement report is locally routed for proximity service with another UE, then the network sends a bias parameter in a Radio Resource Control (RRC) Reconfiguration message to a serving cell at step 1008, where one of the UEs performs cell biasing by sharing via a dedicated mode signaling.

At step 1010, the network verifies whether the UE can sustain a connection with the serving cell, after cell biasing is applied. If connection is sustained, the proximity services continue through the locally routed data path at step 1012. However, if the connection is not sustained, the network determines if another UE can be rerouted to another serving cell at step 1014.

If rerouting is possible to another serving cell at step 1014, the network initiates a cell handover for providing proximity services to the new serving cell so that both the UEs are communicating with a locally routed data path over another serving cell at step 1016. However, if the rerouting is not possible at step 1014, the network determines if a data path can be a direct data path for communication between both the UEs at step 1018.

If the data path can be a direct data path for communication between both the UEs, the network establishes a direct data path and proximity services are provided over a direct data path between both the UEs. If the data path cannot be a direct data path for communication between both the UEs, the network applies the default data path and the normal rule for deciding the handover and performing the handover at step 1022.

As illustrated in FIG. 10, both the UEs having locally routed data path for communication may be kept on a same serving cell for as long as possible. In the worst case, even after applying the cell bias, when the new cell is better for handover evaluation, the network may decide to handover the UE to the new cell, and simultaneously redirect another UE from a serving cell to the new cell, or either to allow a “direct data path” between the two UEs, or a “default data path” between the two UEs, if the serving cells for both the UEs should be different.

Although specific examples have been used in the above-described embodiments; it will be evident that various modifications and changes may be made to these embodiments without departing from the broader spirit and scope thereof. Further, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

While the present disclosure includes reference to certain embodiments thereof, it will be understood by those of ordinary skill in the art that various changes in form and details may be made therein without departing from the spirit and scope of the present disclosure as defined by the following claims and their equivalents.

What is claimed is:

1. A method of reducing signaling overhead in a wireless communication system, the method comprising:
establishing device-to-device communication between a first User Equipment (UE1) and a second User Equipment (UE2) over a locally routed data path;
sending, by the UE1, a signal quality measurement report to a network;
identifying, by the network, that the UE1 is locally routed for proximity services with the UE2;
applying, by the network, cell biasing to a serving cell for at least one of the UE1 or the UE2;
verifying, after the cell biasing, whether the at least one of the UE1 or the UE2 sustains a connection with the serving cell; and
continuing the proximity services through the locally routed data path, if the at least one of the UE1 or the UE2 sustains the connection with the serving cell.

2. The method of claim 1, wherein the network performs cell biasing during a handover evaluation.

3. The method of claim 1, further comprising;
determining, by the network, if the at least one of the UE1 or the UE2 can be rerouted to another serving cell, when the at least one of the UE1 or the UE2 cannot sustain the connection with the serving cell, after the cell biasing; and
initiating a cell handover for providing the proximity services through the another serving cell, if the at least one of the UE1 or the UE2 can be rerouted to the another serving cell.

4. The method of claim 1, further comprising:
determining, by the network, if the at least one of the UE1 or the UE2 can be rerouted to another serving cell, when the at least one of the UE1 or the UE2 cannot sustain the connection with the serving cell, after the cell biasing;
establishing a direct data path for communication between the UE1 and the UE2, if the at least one of the UE1 or the UE2 cannot be rerouted to the another serving cell; and
providing the proximity services over the direct data path between the UE1 and the UE2.

5. The method of claim 1, wherein applying the cell biasing to the serving cell reduces a data path overload on the network.

6. The method of claim 1, wherein the UE1 and the UE2 are camped on a same network cell.

7. A method of reducing overhead in an Evolved Universal Terrestrial Radio Access Network (E-UTRAN) during proximity based device communication, the method comprising:
establishing device-to-device communication between a first User Equipment (UE1) and a second User Equipment (UE2) over a locally routed data path;
sending, by the UE1, a signal quality measurement report to a network;
identifying, by the network, that the UE1 is locally routed for proximity services with the UE2;
sending, by the network, to at least one of the UE1 or the UE2, a change cell command for adding cell bias for a serving cell;
verifying whether the at least one of the UE1 or the UE2 sustains a connection with the serving cell, after the cell biasing; and
continuing with the proximity services through the locally routed data path, if the at least one of the UE1 or the UE2 sustains the connection with the serving cell.

8. The method of claim 7, further comprising:
determining, by the network, if the at least one of the UE1 or the UE2 can be rerouted to another serving cell, when the at least one of the UE1 or the UE2 cannot sustain the connection with the serving cell, after the cell biasing; and
initiating a cell handover for providing the proximity services to the another serving cell, if the at least one of the UE1 or the UE2 can be rerouted to the another serving cell.

9. The method of claim 7, further comprising:
determining, by the network, if the at least one of the UE1 or the UE2 can be rerouted to another serving cell, when the at least one of the UE1 or the UE2 cannot sustain the connection with the serving cell, after the cell biasing;
establishing a direct data path for communication between the UE1 and the UE2, if the at least one of the UE1 or the UE2 cannot be rerouted to the another serving cell; and
providing the proximity services over the direct data path between the UE1 and the UE2.

10. The method of claim 7, wherein the at least one of the UE1 or the UE2 performs the cell biasing by sharing via a dedicated mode signaling.

11. The method of claim 7, wherein the UE1 and the UE2 are camped on a same network cell.

12. A network apparatus for reducing signaling overhead in a wireless communication system, the network apparatus comprising:
a transceiver for communicating with a first user equipment (UE1) that performs device-to-device (D2D) communication with a second user equipment (UE2) over a locally routed data path; and
a controller configured to control receiving, from the UE1, a signal quality measurement report, to identify if the UE1 is locally routed for proximity services with the UE2, to apply cell biasing to a serving cell for at least one of the UE1 or the UE2, to verify whether the at least one of the UE1 or the UE2 sustains connection with the serving cell, after the cell biasing, and to control continuing the proximity services through the locally routed data path, if the at least one of the UE1 or the UE2 sustains the connection with the serving cell.

13. The network apparatus of claim 12, wherein the controller is further configured to:
determine if the at least one of the UE1 or the UE2 can be rerouted to another serving cell, when the at least one of the UE1 or the UE2 cannot sustain the connection with the serving cell, after the cell biasing; and
initiate a cell handover for providing the proximity services to the another serving cell, if the at least one of the UE1 or the UE2 can be rerouted to the another serving cell.

14. The network apparatus of claim 12, wherein the controller is further configured to:
determine if the at least one of the UE1 or the UE2 can be rerouted to another serving cell, when the at least one of the UE1 or the UE2 cannot sustain the connection with the serving cell, after the cell biasing; and
establish a direct data path for communication between the UE1 and the UE2, if the at least one of the UE1 or the UE2 cannot be rerouted to the another serving cell,
wherein the proximity services are provided over the direct data path between the UE1 and the UE2.

15. The network apparatus of claim 12, wherein the controller applies the cell biasing to the serving cell to reduce a data path overload on the network apparatus.

16. The network apparatus of claim 12, wherein the UE1 and the UE2 are camped on a same network cell of the network apparatus.
